(19) United States
(12) Patent Application Publication
(10) Pub. No.: US 2022/0058759 A1
(43) Pub. Date: Feb. 24, 2022

(54) METHOD FOR DIVIDING OVERLAPPING BOUNDARIES OF NATURAL RESERVES

(71) Applicant: Ministry of Ecology and Environment Center for Satellite Application on Ecology Environment, Beijing (CN)

(72) Inventors: Xiaoman LIU, Beijing (CN); Chuanping JIN, Beijing (CN); Peng HOU, Beijing (CN); Wandong MA, Beijing (BJ); Wenguo ZHANG, Beijing (CN); Yong WANG, Beijing (CN); Rulin XIAO, Beijing (CN); Zhuo FU, Beijing (CN); Chao WANG, Beijing (CN); Na LV, Beijing (CN); Ruihong WEN, Beijing (CN); Xuefeng WANG, Beijing (CN); Jing HOU, Beijing (CN); Chenxi SUN, Beijing (CN); Bin MENG, Beijing (CN); Yangyang SUN, Beijing (CN); Jingfang YUAN, Beijing (CN); Yang PENG, Beijing (CN)

(21) Appl. No.: 17/407,090

(22) Filed: Aug. 19, 2021

(30) Foreign Application Priority Data
Aug. 19, 2020 (CN) 2020108392641

(51) Int. Cl. G06Q 50/26; G06K 9/62

(52) U.S. Cl. CPC G06Q 50/26; G06K 9/6282

(57) ABSTRACT

A method for dividing overlapping boundaries of natural reserves is disclosed. The method includes: S1, classifying the boundaries of different types of the natural reserves; S2, extracting the boundaries overlapping area of different types of the natural reserves; S3, calculating the absolute overlapping rate between each natural reserve and other natural reserves; S4. calculating the absolute number of overlapping between each natural reserves and other natural natural reserves; S5. obtaining a continuous overlapping area model based on the absolute number of overlapping; S6. classifying the continuous overlapping area model according to the continuous overlapping area model to obtain clustering characteristics of each region. A quantitative method can be provided for the overlapping characteristics and relationship of the spatial boundaries of different types of natural reserves.

### CROSS REFERENCE TO RELATED APPLICATION

This patent application claims the benefit and priority of Chinese Patent Application No. 202010839264.1 filed on Aug. 19, 2020, the disclosure of which is incorporated by reference herein in its entirety as part of the present application.

### TECHNICAL FIELD

The present disclosure relates to the technical field of ecological environmental protection supervision, and more specifically, to a method for dividing the overlapping boundaries of natural reserves.

### BACKGROUND ART

As the most essential and important part of the natural ecological space in China, the natural reserves are the core carrier of the construction of ecological civilization, and occupy the first place in the maintenance of national ecological security. After more than 60 years of practice and development, China has established a system consisting of nature reserves, scenic spots, forest parks, geoparks and wetland parks with various types and diverse functions. However, while the construction of natural conservation sites in China has made great achievements, there is still the phenomenon of overlapping among different types of natural reserves. The overlapping of natural reserves tends to lead to disputes over the right of management, increase management costs, waste management resources, and affect the overall conservation effectiveness of natural reserves in China. It is difficult to meet the requirements of safeguarding national ecological security and maintaining biodiversity. The quantitative research on the characteristics of the boundaries crossing and overlapping of nature reserves is the basic work of the integration and optimization of nature reserves in China, and it is necessary to clarify the spatial overlapping characteristics of various types of nature reserves. It is an urgent problem to be solved in optimizing the system of natural reserves in China.

In existing arts, the boundary overlapping and spatial distribution characteristics of different types of natural reserves in China are analyzed mainly based on the method of kernel density analysis, geographical concentration index, Gini coefficient and the like. In those methods, the kernel density analysis is mainly based on the point-location density to obtain the high-density regions of the natural reserves, the hot spots or regions that are very likely overlapped are thus concluded. The geographical concentration index and Gini coefficient are more about the calculation of spatial distributions, and the distribution characteristics in a certain spatial region can be obtained qualitatively. The above methods are difficult to better quantify the complex overlapping characteristics and relationships among various types of nature reserves at all levels, and cannot provide precise data support for the optimization and integration of cross-overlapping nature reserves.

Therefore, it is an urgent problem for those skilled in the art to propose a method that can accurately quantify the boundaries overlapping characteristics of the natural reserves.

### SUMMARY

In view of the above, the present disclosure provides a method for dividing the overlapping boundaries of the natural reserves. The present disclosure provides a method for quantifying the overlapping characteristics and relationships of the spatial boundaries of different types of the natural reserves, which can systematically clarify the cross-overlapping relationship of complex natural natural reserves.

In order to achieve above purpose, a method for dividing overlapping boundaries overlapping of natural reserves is provided. The method includes:

S1. classifying boundaries with different types of the natural reserves;

S2. extraction of boundaries overlapping region of different types of natural reserves: dividing the boundaries of natural reserves into different layers according to the types; extracting intersection parts with overlapping relationship in the layers according to a principle of permutation and combination;

S3. calculating an absolute overlapping ratio between each natural reserve with respect to other natural reserves; the absolute overlapping ratio is the ratio of the area of a current natural reserve overlapping with other natural reserves to the total area of the current natural reserve;

S4. calculating the number of absolute overlapping between each natural reserve and other natural reserves; the number of absolute overlapping is the number of other natural reserves in overlapping relationship with the current natural reserve;

S5. obtaining a continuous overlapping region model based on the number of the absolute overlapping; wherein a method for obtaining the continuous overlapping region model includes:

sorting the absolute overlapping number of all the natural reserves from large to small; taking the natural reserve with the largest absolute overlapping number as a root node; taking the natural reserves with an overlapping area with the root node as a child node of the root node; then sequentially taking the natural reserves having an overlapping area with the child node of the root node as the next-level child node until a natural reserve having an absolute overlapping number of 1 is taken as a leaf node; and

S6. grading and classifying based on the the continuous overlapping region model to obtain clustering characteristics of each regions.

Preferably, different types of natural reserves are classified, forming separate boundaries layers for various types of natural reserves; the types of natural reserves include nature reserves, forest parks, wetland parks, geoparks and scenic spots.

Preferably, in step S2, the intersecting parts with overlapping relationship are extracted from each layer according to the principle of permutation and combination, and the intersecting principle is as follows:

$${C}_{m}^{n} = \frac{m !}{n ! ( m - n ) !} .$$

wherein m is the total number of natural reserves types, n is the number of natural reserves types involved in the intersection, and the obtained result Cₘⁿ is the number of times of intersection, and after the intersection, regions having an overlapping relationship between all types are obtained, which includes areas that overlapped multiple times.

Preferably, a formula of the absolute overlapping ratio in S3 is:

$$A O R = \frac{{\sum }_{1 \leq i \leq j \leq m} \vert {A}_{i} ⋂ {A}_{j} \vert - {\sum }_{1 \leq i \leq j \leq k \leq m} \vert {A}_{1} ⋂ {A}_{j} ⋂ {A}_{k} \vert + …… - {( - 1 )}^{m - 1} \vert {A}_{1} ⋂ {A}_{2} ⋂ {A}_{3} …… ⋂ {A}_{m} \vert}{A}$$

wherein, the AOR represents the absolute overlapping ratio, the numerator represents the absolute overlapping area, and A represents the total area of the natural reserves.

When 0<AOR≤1, the larger the value of AOR is, the larger the area of the current natural reserve overlapping with other natural reserves; when AOR=1, all parts of the current nature reserve have an overlapping relationship with other nature reserves.

Preferably, a classification result of the grading and classifying in the step S6 includes a high continuous overlapping region, a general overlapping region, a simple overlapping region and a non-overlapping region.

Preferably, the method further includes the steps of integrating all kinds of natural reserves according to the classification result of S6, solving the problem of area crossing and space overlapping of natural reserves, and performing a type integration on different types of natural reserves from the perspective of regional and service function.

As can be seen from the above technical solution, compared with the prior art, the present disclosure provides a method for quantifying a boundary overlapping characteristics of natural reserves. In the disclosure, the relative overlapping area is obtained by analyzing the overlap times, the overlap amount, the overlap rate and the overlap property of the natural reserves. The absolute overlapping rate of a single natural reserve is obtained according to the absolute overlapping rate formula, and the number of absolute overlapping is obtained according to the number of association with the single natural reserve. In addition, the continuous overlapping region is further extended to obtain the number of natural reserves in the continuous overlapping region, and the number of natural reserves in the continuous overlapping region is sorted and the degree of division is carried out according to the number, so as to realize the quantitative result of the overlapping relation of natural reserves. In the disclosure, a quantitative method can be provided for the overlapping characteristics and relationship of the spatial boundaries of different types of natural reserves. It can provide scientific basis for the spatial planning and layout selection of the natural reserve system, and provide data calculation methods for the optimization and integration of the natural reserves and the construction of national parks.

### BRIEF DESCRIPTION OF THE DRAWINGS

In order to more clearly explain that embodiments of the present disclosure or the technical scheme in the prior art, the following brief description will be given of the drawings which are required for use in the description of the embodiments or the prior art. Obviously, the drawings in the following descriptions are merely embodiments of the present disclosure, and for those skilled in the art, other drawings may be obtained on the basis of the drawings provided without any creative efforts.

FIG. 1 is a flowchart of a method for dividing overlapping boundaries of natural reserves provided by the present disclosure;

FIG. 2 is a continuous overlapping area model according to an embodiment of the present disclosure;

FIG. 3 is a schematic diagram of a relative overlapping relationship with a first overlapping area in an embodiment of the present disclosure;

FIG. 4 is a continuous overlapping region model with two overlapping regions in an embodiment of the present disclosure;

FIG. 5 is a schematic diagram of the absolute overlapping ratio of a single natural reserve in an embodiment of the present disclosure.

### DETAILED DESCRIPTION OF THE EMBODIMENTS

In the following, technical solutions in the embodiment of the present disclosure will be clearly and completely described with reference to the accompanying drawings in the embodiment of the present disclosure. It is obvious that the described embodiments are only a part of the embodiments of the present disclosure, but not all of the embodiments. Based on the embodiments of the present disclosure, all other embodiments obtained by the ordinary person skilled in the art without creative efforts fall within the scope of protection of the present disclosure.

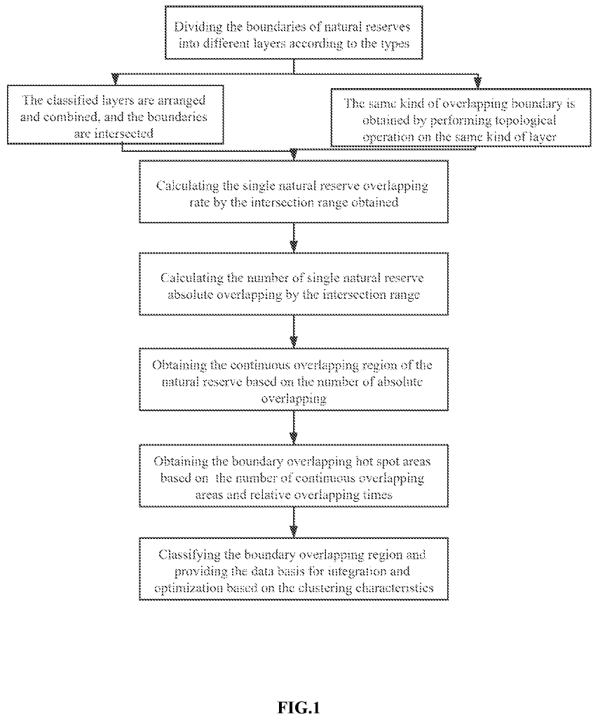

A method for dividing the overlapping boundaries of the natural reserves, as shown in FIG. 1, is provided in the embodiment of the present disclosure. The method includes the steps below.

S1. classifying boundaries with different types of the natural reserves;

S2. extraction of boundaries overlapping region of different types of natural reserves: dividing the boundaries of natural reserves into different layers according to the types; extracting the intersection parts with overlapping relation in the layers according to a principle of permutation and combination.

S3. calculating an absolute overlapping ratio between each natural reserve with respect to other natural reserves. The absolute overlapping ratio is the ratio of the area of a current natural reserve overlapping with other natural reserves to the total area of the current natural reserve.

S4. calculating the number of absolute overlapping between each natural reserve and other natural reserves; the number of absolute overlapping is the number of other natural reserves in overlapping relationship with the current natural reserve;

S5. obtaining a continuous overlapping region model based on the number of the absolute overlapping. Wherein a method for obtaining the continuous overlapping region model includes:

Sorting the absolute overlapping number of all the natural reserves from large to small; taking the natural reserve with the largest absolute overlapping number as a root node; taking the natural reserves with an overlapping area with the root node as a child node of the root node; then sequentially taking the natural reserves having an overlapping area with the child node of the root node as the next-level child node until a natural reserve having an absolute overlapping number of 1 is taken as a leaf node;

S6. grading and classifying based on the the continuous overlapping region model to obtain clustering characteristics of each regions.

It should be noted that:

The method for obtaining the continuous overlapping region model in S5 is further described with an example as follows:

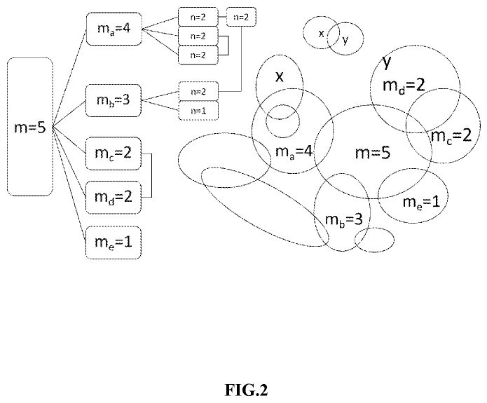

As shown in FIG. 2, the number of absolute overlapping with the natural reserves itself is denoted by m, and the natural reserves having the maximum number of absolute overlapping is taken as the root node, that is, m=5 in the figure. Then, the other protection reserves intersecting with it are taken as its child nodes, namely mₐ, m_{b}, m_{c}, m_{d} and mₑ in the figure. The natural reserves having overlapping parts with mₐ, m_{b}, m_{c}, m_{d} and mₑ are respectively regarded as the child nodes of the mₐ, m_{b}, mₑ, m_{d} and mₑ according to the overlapping relationship in the figure. The absolute overlapping number of the child nodes of this level is respectively labeled. The neighboring nodes with overlapping relationship is connected until there is no other overlapping relationship.

In order to further implement the technical solution, the specific content of the step S1 is that different types of natural reserves are classified, forming separate boundaries layers for various types of natural reserves. The types of natural reserves include but are not limited to nature reserves, forest parks, wetland parks, geoparks and scenic spots.

In order to further implement the above technical solution, in the step S2, the intersecting parts with overlapping relationship are extracted from each layer according to the principle of permutation and combination, and the intersecting principle is as follows:

$${C}_{m}^{n} = \frac{m !}{n ! ( m - n ) !} .$$

Wherein m is the total number of natural reserves types, n is the number of natural reserves types involved in the intersection, and the obtained result Cₘⁿ is the number of times of intersection, and after the intersection, regions having an overlapping relationship between all types are obtained, which includes areas that overlapped multiple times.

It needs to be further stated that:

When n=2, according to the principle of intersection of two, the boundaries of the overlapping parts of the two types are intersected and the corresponding range is extracted, see FIG. 3, and the calculation principle is

$${C}_{m}^{2} = \frac{m !}{2 ! ( m - 2 ) !} .$$

When n=3, the boundaries of the overlapping parts of the three types of boundaries are intersected, the corresponding range is extracted, and the area of the intersecting parts is calculated. the calculation principle is

$${C}_{m}^{3} = \frac{m !}{3 ! ( m - 3 ) !}$$

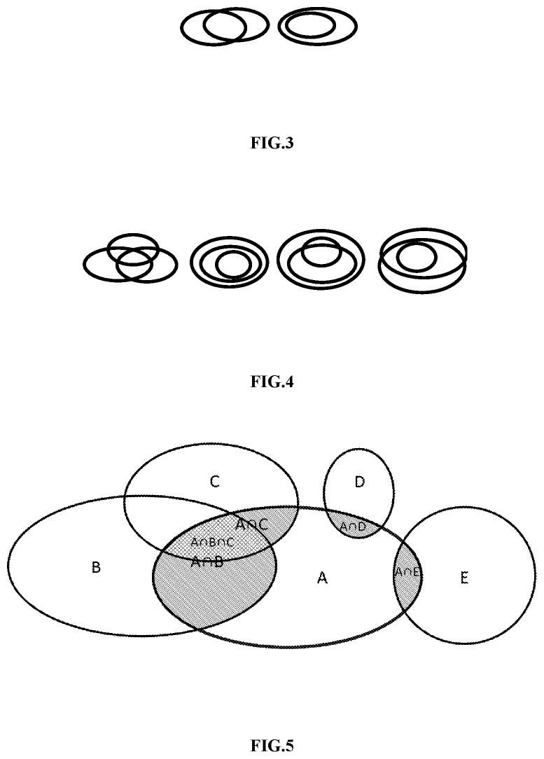

as shown in FIG. 4.

For example, if there are 6 types of natural reserves under study, when calculating the intersection of two types of boundaries, the intersection time of

$${C}_{6}^{2} = \frac{6 !}{2 ! ( 6 - 2 ) !} = 15$$

should be carried out, and after the intersection, the intersection of two types of the natural reserves will be obtained. Then, cases where the boundary intersection of 3 types to 6 types are calculated sequentially, that is, an area having an overlapping relationship between all types, including an area having multiple overlapping times, can be obtained.

In order to further implement the above technical solution, the specific formula of the absolute overlapping ratio in S3 is:

$$A O R = \frac{{\sum }_{1 \leq i \leq j \leq m} \vert {A}_{i} ⋂ {A}_{j} \vert - {\sum }_{1 \leq i \leq j \leq k \leq m} \vert {A}_{1} ⋂ {A}_{j} ⋂ {A}_{k} \vert + …… - {( - 1 )}^{m - 1} \vert {A}_{1} ⋂ {A}_{2} ⋂ {A}_{3} …… ⋂ {A}_{m} \vert}{A}$$

Wherein, the AOR represents the absolute overlapping ratio, the numerator represents the absolute overlapping area, and A represents the total area of the natural reserves.

It needs to be further stated that:

The absolute overlapping ratio is actually obtained by the above-mentioned regular combination of all the nature reserves which have a relative overlapping relationship with a certain nature reserve. The natural reserve A in the following figure is taken as an example:

As shown in FIG. 5, the absolute overlapping ratio of the natural reserve A is calculated as follows:

$$AOR = \frac{M {J}_{A ⋂ B} + M {J}_{A ⋂ C} + M {J}_{A ⋂ D} + M {J}_{A ⋂ E} - M {J}_{A ⋂ B ⋂ C}}{M {J}_{A}}$$

Where MJ is the area. When the boundaries overlap to a complex situation, and so on.

The above steps are repeated to obtain the absolute overlapping rate of all N protected sites.

In order to further implement the above technical scheme, when 0<AOR≤1, the larger the value of AOR is, the larger the area of the current natural reserve overlapping with other natural reserves. When AOR=1, all parts of the current nature reserve have an overlapping relationship with other nature reserves.

In order to further implement the above technical solution, the classification result of grading and classifying in S6 includes a high continuous overlapping region, a general overlapping region, a simple overlapping region and a non-overlapping region. The absolute overlapping rate of the above categories are analyzed. For example, in the simple overlapping region, when the absolute overlapping rate of a certain natural reserve is very high, even up to 100%, the reserve can be directly incorporated into other reserves. When the high continuous overlapping region generally involves a large number of natural reserves, while the absolute overlapping rate of some of the natural reserves is low, it can be divided separately by means of range adjustment or boundaries marking, etc.

In order to further implement the technical solution, the method further includes the following steps of integrating all kinds of natural reserves according to the classification result of S6, solving the problem of area crossing and space overlapping of natural reserves, and performing a type integration on different types of natural reserves from the perspective of regional and service function. For example, the continuous overlapping area has multiple types of reserves and diverse protected objects, such as forest parks, animals and plant protection areas, geoparks and scenic spots. In addition, the number of continuous overlapping and some absolute overlapping rates are relatively high, which should be the preferred areas of national parks, such as wetland parks, aquatic germplasm reserves, water conservancy scenic areas and wetland waterbird reserves. The protection objects and the service function are identical, and should be merged or adjusted into the conservation area or the natural park.

Each embodiments in the specification are described in a progressive manner, and each embodiment focuses on the differences between the embodiments and the other embodiments, and the same similar parts among the embodiments may be referred to each other. For the device disclosed in the embodiment, since it corresponds to the method disclosed in the embodiment, the description is relatively simple, and for the relevant parts, it can refer to the description of the method part.

The foregoing description of the disclosed embodiments enables those skilled in the art to make or use the present disclosure. Various modifications to these embodiments will be apparent to those skilled in the art. The general principles defined herein may be implemented in other embodiments without departing from the spirit or scope of the invention. Accordingly, the present invention will not be limited to the embodiments shown herein, but will be accorded the widest scope consistent with the principles and novel features disclosed herein.

What is claimed is:

1. A method for dividing overlapping boundaries overlapping of natural reserves, comprising:
S1. classifying boundaries with different types of the natural reserves;
S2. extraction of boundaries overlapping region of different types of natural reserves: dividing the boundaries of natural reserves into different layers according to the types; extracting intersection parts with overlapping relationship in the layers according to a principle of permutation and combination;
S3. calculating an absolute overlapping ratio between each natural reserve with respect to other natural reserves; the absolute overlapping ratio is the ratio of the area of a current natural reserve overlapping with other natural reserves to the total area of the current natural reserve;
a formula of the absolute overlapping ratio in S3 is:
$$A O R = \frac{{\sum }_{1 \leq i \leq j \leq m} \vert {A}_{i} ⋂ {A}_{j} \vert - {\sum }_{1 \leq i \leq j \leq k \leq m} \vert {A}_{1} ⋂ {A}_{j} ⋂ {A}_{k} \vert + …… - {( - 1 )}^{m - 1} \vert {A}_{1} ⋂ {A}_{2} ⋂ {A}_{3} …… ⋂ {A}_{m} \vert}{A}$$
wherein, the AOR represents the absolute overlapping ratio, the numerator represents the absolute overlapping area, and A represents the total area of the natural reserves;
when 0<AOR≤1, the larger the value of AOR is, the larger the area of the current natural reserve overlapping with other natural reserves; when AOR=1, all parts of the current nature reserve have an overlapping relationship with other nature reserves;
S4. calculating the number of absolute overlapping between each natural reserve and other natural reserves; the number of absolute overlapping is the number of other natural reserves in overlapping relationship with the current natural reserve;
S5. obtaining a continuous overlapping region model based on the number of the absolute overlapping; wherein a method for obtaining the continuous overlapping region model includes:
sorting the absolute overlapping number of all the natural reserves from large to small; taking the natural reserve with the largest absolute overlapping number as a root node; taking the natural reserves with an overlapping area with the root node as a child node of the root node; then sequentially taking the natural reserves having an overlapping area with the child node of the root node as the next-level child node until a natural reserve having an absolute overlapping number of 1 is taken as a leaf node;
S6. grading and classifying based on the the continuous overlapping region model to obtain clustering characteristics of each regions.

2. The method of claim 1, wherein different types of natural reserves are classified, forming separate boundaries layers for various types of natural reserves; the types of natural reserves include nature reserves, forest parks, wetland parks, geoparks and scenic spots.

3. The method of claim 1, wherein in the step S2, the intersecting parts with overlapping relationship are extracted from each layer according to the principle of permutation and combination, and the intersecting principle is as follows:
$${C}_{m}^{n} = \frac{m !}{n ! ( m - n ) !} .$$
wherein m is the total number of natural reserves types, n is the number of natural reserves types involved in the intersection, and the obtained result Cₘⁿ is the number of times of intersection, and after the intersection, regions having an overlapping relationship between all types are obtained, which includes areas that overlapped multiple times.

4. The method of claim 1, wherein a classification result of the grading and classifying in the step S6 includes a high continuous overlapping region, a general overlapping region, a simple overlapping region and a non-overlapping region.

5. The method of claim 1, wherein the method further includes the steps of integrating all kinds of natural reserves according to the classification result of S6, solving the problem of area crossing and space overlapping of natural reserves, and performing a type integration on different types of natural reserves from the perspective of regional and service function.
